(19) United States
(12) Patent Application Publication
(10) Pub. No.: US 2026/0051639 A1
(43) Pub. Date: Feb. 19, 2026

(54) MANUFACTURING APPARATUS FOR SECONDARY BATTERY, AND MANUFACTURING METHOD FOR SECONDARY BATTERY

(71) Applicant: SK On Co., Ltd., Seoul (KR)

(72) Inventors: Jun Hui JEONG, Daejeon (KR); Gi Su JEONG, Daejeon (KR); Byeong Gwon LEE, Daejeon (KR)

(21) Appl. No.: 19/270,482

(22) Filed: Jul. 16, 2025

(30) Foreign Application Priority Data
Aug. 16, 2024 (KR) 10-2024-0109885

(51) Int. Cl. H01M 50/609

(52) U.S. Cl. CPC H01M 50/609

(57) ABSTRACT

The present disclosure relates to manufacturing apparatus for secondary battery and a manufacturing method for secondary battery. The manufacturing apparatus for secondary battery according to an embodiment of the present disclosure includes a support portion on which a preliminary battery including a first electrode and a second electrode is mounted and supported; a power supply applying a current or a voltage to the preliminary battery; and an injection portion injecting an electrolyte solution into the preliminary battery.

### CROSS-REFERENCE TO RELATED PATENT APPLICATION

The present disclosure claims priority under 35 U.S.C. § 119(a) to Korean patent application number 10-2024-0109885, filed on Aug. 16, 2024, the entire disclosure of which is incorporated herein by reference.

### BACKGROUND OF THE INVENTION

### 1. Field

Various embodiments of the present disclosure generally relate to manufacturing apparatus for secondary battery, and a manufacturing method for secondary battery.

### 2. Description of the Related Art

Secondary batteries are batteries which convert electrical energy into chemical energy and store the chemical energy so that the chemical energy may be reused multiple times through charging and discharging, and batteries in which an electrode assembly including an electrode (a cathode and an anode) and an electrolyte solution are housed together in a case are generally used.

The electrode assembly may be configured in a state of being impregnated with the electrolyte solution inside the case. For smooth performance development of batteries, the penetration of electrolyte solution into the electrode assembly is essential, and as a result, the degree of electrolyte solution impregnation may be a very important factor in determining the performance of secondary batteries.

For sufficient impregnation, the electrode assembly may require a relatively long standing time after the electrolyte solution is injected. However, when the standing time is prolonged, side reactions such as elution of current collector metal, case metal, or the like in the electrode assembly may occur. In addition, the long standing time may result in degradation in processability by increasing the time required for the entire process.

### SUMMARY OF THE INVENTION

According to an aspect of the present disclosure, manufacturing apparatus for secondary battery may be provided which is capable of performing both an injection process and an activation process with one piece of equipment.

According to another aspect of the present disclosure, a manufacturing method for secondary battery may be provided in which the time required for a process is shortened through an efficient impregnation process.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

Manufacturing apparatus for secondary battery according to an embodiment of the present disclosure includes a support portion on which a preliminary battery including a first electrode and a second electrode is mounted and supported; a power supply applying a current or a voltage to the preliminary battery; and an injection portion injecting an electrolyte solution into the preliminary battery. The power supply includes a power module electrically connected to the first electrode and the second electrode of the preliminary battery to apply the current or the voltage to the first electrode and the second electrode; a first electrode potential measuring module electrically connected to the first electrode of the preliminary battery to measure a potential of the first electrode; and a second electrode potential measuring module electrically connected to the second electrode of the preliminary battery to measure a potential of the second electrode.

According to an embodiment, the first electrode potential measuring module may measure a potential relative to a lithium redox potential of the first electrode.

According to an embodiment, the first electrode potential measuring module may include a first reference electrode connected to the first electrode to provide a predetermined reference potential.

According to an embodiment, the second electrode potential measuring module may measure a potential relative to a lithium redox potential of the second electrode.

According to an embodiment, the second electrode potential measuring module may include a second reference electrode connected to the second electrode to provide a predetermined reference potential.

According to an embodiment, the manufacturing apparatus for secondary battery may further include a controller controlling the power supply and the injection portion. The power supply may further include a power control module controlling the power module according to an instruction of the controller. The power control module may include an impregnation process control unit controlling the current or the voltage applied from the power module to the preliminary battery based on the potential of the first electrode measured by the first electrode potential measuring module and the potential of the second electrode measured by the second electrode potential measuring module.

According to an embodiment, the power control module may further include an activation process control unit controlling a charge/discharge current or voltage applied from the power module to the preliminary battery.

According to an embodiment, the injection portion may include an injection tank storing the electrolyte solution; an injection line having one end connected to the injection tank and another end connected to the preliminary battery to provide an injection path for the electrolyte solution; an injection pump causing the electrolyte solution to flow from the injection tank to the preliminary battery; and a vacuum pump controlling pressure inside the preliminary battery.

A manufacturing method for secondary battery according to an embodiment of the present disclosure includes a preparation step of arranging a preliminary battery including a first electrode and a second electrode; an injection step of injecting an electrolyte solution into the preliminary battery after the preparation step; and a voltage application step of applying a voltage to the first electrode and the second electrode of the preliminary battery after the preparation step. In the voltage application step, the voltage is applied to the first electrode and the second electrode so that the first electrode reaches a first potential and the second electrode reaches a second potential.

According to an embodiment, the first electrode may include a lithium metal oxide as a first electrode active material.

According to an embodiment, the lithium metal oxide may be a nickel-cobalt-manganese (NCM)-based oxide.

According to an embodiment, the second electrode may include a carbon-based active material or a silicon-based active material as a second electrode active material.

According to an embodiment, after one of the injection step and the voltage application step is performed, another step may sequentially be performed.

According to an embodiment, the injection step and the voltage application step may be performed in parallel.

According to an embodiment, the first potential may be between 3 V and 3.6 V relative to a lithium redox potential.

According to an embodiment, the second potential may be between 2 V and 3 V relative to a lithium redox potential.

According to an embodiment, the method may further include an aging step of leaving the preliminary battery at room temperature after the injection step and the voltage application step.

According to an embodiment, the aging step may be performed for up to 24 hours.

According to an embodiment, the method may further include a pre-charge step for activating the preliminary battery after the aging step.

The secondary battery according to the present disclosure may be manufactured by a method including the manufacturing method for secondary battery according to the present disclosure.

According to an aspect of the present disclosure, manufacturing apparatus for secondary battery may be provided which is capable of performing both an injection process and an activation process with one piece of equipment.

According to another aspect of the present disclosure, a manufacturing method for secondary battery may be provided in which the time required for a process is shortened through an efficient impregnation process.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

### BRIEF DESCRIPTION OF THE DRAWINGS

FIG. 1 is a block diagram illustrating manufacturing apparatus according to an embodiment of the present disclosure;

FIG. 2 is a block diagram illustrating a system for controlling a power supply according to an embodiment of the present disclosure;

FIG. 3 is a diagram illustrating an example in which a preliminary battery is arranged in manufacturing apparatus according to an embodiment; and

FIG. 4 is a diagram illustrating another example in which a preliminary battery is arranged in manufacturing apparatus according to an embodiment.

### DETAILED DESCRIPTION

Embodiments described herein may be modified in many other ways, so that the technology according to an embodiment is not limited to the embodiments described herein. Further, throughout the specification, references to “including,” “comprising,” “containing,” or “having” any component are not intended to exclude other components, but rather to indicate that other components may be further included unless otherwise stated, and are not intended to exclude elements, materials, or processes not further enumerated.

As used herein, equal or uniform may mean identical or uniform to each other within acceptable tolerances unless otherwise specified. For example, equal in composition or physical property measurements may mean that the two objects being compared are identical within tolerances, as well as being exactly the same. Having the same physical property measurements may mean that the difference in the measurements between the objects is about less than 5%, specifically less than 3%, or more specifically less than 1%.

As used herein, that angles formed by two objects are perpendicular or parallel to each other may include not only being geometrically perpendicular or parallel, but also being within slight tolerances.

As used herein, numerical ranges include upper and lower bounds and all values within them, increments logically derived from the shape and width of the range being defined, all doubly bounded values, upper and lower bounds of numerical ranges bounded in different forms, and all possible combinations thereof.

Unless otherwise defined herein, “about” may be considered to be a value within 30%, 25%, 20%, 15%, 10%, or 5% of the stated value.

The use of the terms “first,” “second,” “third,” and the like before any component in this specification is intended to avoid confusion as to the component to which it refers, and is not intended to indicate any order, importance, or master-slave relationship between the components. For example, an embodiment may include only the second component without the first component.

As used herein, the term “electrically connected” may mean without limitation any connection method by which a plurality of objects may be connected to each other so as to be in electrical communication with each other, and may be implemented in various aspects such as direct connection of the plurality of objects connected to each other or connection through a third object.

A configuration defined herein as a “portion”, “module”, or “unit” may mean, without limitation, a single component or a set of two or more identical or similar components having common functional aspects, and the set of components may be configured by combining hardware and/or software without limitation.

As used herein, “arranged” may mean, without limitation, a positional relationship by which one object may be positioned adjacent to another object. By way of non-limiting example, it may mean coating one object with another object, adhering one object with another through an adhesive material, fusing one object with another by applying heat, pressure, or the like, or simply positioning or fixedly positioning at least a portion of one object in any space so that it abuts at least the portion of another object.

As used herein, the term “secondary battery” may refer to a battery which generates electrical energy through oxidation and reduction reactions when ions, specifically cations such as lithium ions, are inserted into and extracted from a cathode and an anode. Specifically, the “secondary battery” may mean any one of a lithium cobalt battery, a lithium high-nickel battery, a lithium iron phosphate battery, a lithium ion battery, a lithium polymer battery, a lithium sulfur battery, a nickel hydrogen battery, a nickel cadmium battery, a sodium battery, and an all-solid-state battery. More specifically, the term “secondary battery” as used herein may mean, but is not necessarily limited to, a lithium ion secondary battery.

As used herein, the term “battery cell” may refer to the basic unit of a secondary battery which may charge and discharge electrical energy, including an electrode assembly, an electrolyte solution, and a case as main components thereof.

As used herein, the term “preliminary battery” may mean, but is not limited to, an unfinished battery cell.

Hereinafter, embodiments of the present disclosure will be described in detail. However, this is by way of example only and the invention is not limited to the specific embodiments described herein.

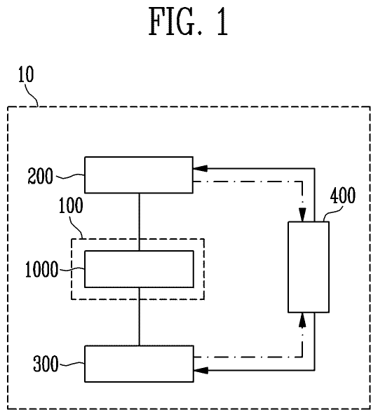

FIG. 1 is a block diagram illustrating manufacturing apparatus according to an embodiment of the present disclosure.

Manufacturing apparatus for secondary battery 10 according to an embodiment of the present disclosure includes: a support portion 100 on which a preliminary battery 1000 including a first electrode and a second electrode is mounted and supported; a power supply 200 applying a current or a voltage to the preliminary battery 1000; and an injection portion 300 for injecting an electrolyte solution into the preliminary battery 1000. The power supply 200 may include a power module 210 electrically connected to the first electrode and the second electrode of the preliminary battery 1000 to apply a current or a voltage to the first electrode or the second electrode, a first electrode potential measuring module 220 electrically connected to the first electrode of the preliminary battery 1000 to measure a potential of the first electrode, and a second electrode potential measuring module 230 electrically connected to the second electrode of the preliminary battery 1000 to measure a potential of the second electrode.

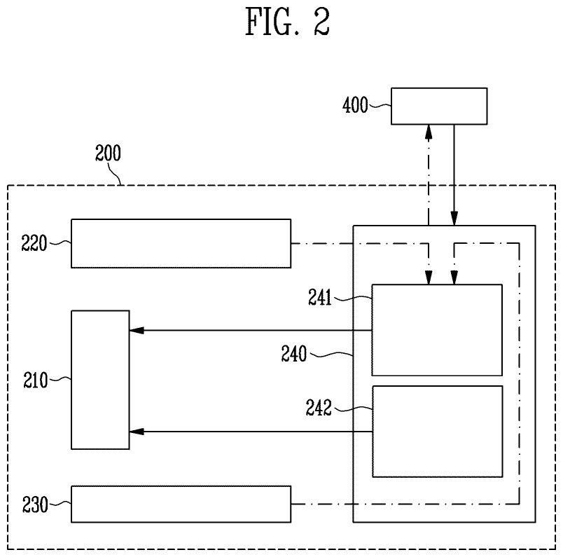

In FIGS. 1 and 2, a straight arrow may mean a control path, and a dashed-dotted arrow may mean an information transmission path, but are not necessarily limited thereto.

In an embodiment, the preliminary battery 1000 may refer to a battery cell which is not finally finished. For example, the preliminary battery 1000 may refer to a preliminary battery which includes an electrode assembly and a case accommodating the electrode assembly therein, and which is in a state in which an electrolyte solution is not injected into the case, which may be referred to as a first preliminary battery. The first preliminary battery may mean a preliminary battery before undergoing an impregnation process to be described below. In another embodiment, the preliminary battery 1000 may mean a preliminary battery, which includes an electrode assembly, a case accommodating the electrode assembly therein, and an electrolyte solution accommodated in the case together with the electrode assembly to impregnate the electrode assembly, and which is in a state not yet activated, and may be referred to as a second preliminary battery. The second preliminary battery may mean a preliminary battery which has undergone the impregnation process to be described below and has not yet undergone an activation process.

In an embodiment, the manufacturing apparatus may be implemented as single apparatus. The manufacturing apparatus may be implemented in the form in which separate pieces of apparatus in charge of detailed functions are integrated into single apparatus.

In an embodiment, the manufacturing apparatus 10 may include the support portion 100 on which the preliminary battery 1000 is mounted and supported to prevent or mitigate a process failure caused by an unintended movement of the preliminary battery 1000 during a manufacturing process according to the present disclosure. In an embodiment, the support portion 100 may fixedly support the preliminary battery 1000 mounted thereto does not move.

In an embodiment, the support portion 100 may be implemented in the form of a support member. In an embodiment, the support member may mean, for example, a jig or a fixing plate.

As will be described below, the secondary battery manufactured according to embodiments of the present disclosure may mean a can-type secondary battery, and the can-type secondary battery may be classified into a prismatic secondary battery or a cylindrical secondary battery according to the shape of a case of a battery cell. Therefore, the support portion 100 may be implemented in a non-limiting manner according to the shape of the case.

FIG. 2 is a block diagram illustrating a system for controlling the power supply 200 according to an embodiment of the present disclosure.

In an embodiment, the power supply 200 may apply a current or a voltage to the preliminary battery 1000. To this end, the power supply 200 may include the power module 210 electrically connected to the first electrode and the second electrode of the preliminary battery 1000 to apply a current or a voltage to the first electrode or the second electrode, the first electrode potential measuring module 220 electrically connected to the first electrode of the preliminary battery 1000 to measure a potential of the first electrode, and the second electrode potential measuring module 230 electrically connected to the second electrode of the preliminary battery 1000 to measure a potential of the second electrode.

In an embodiment, the power supply 200 may be implemented as single power supply apparatus. The power supply apparatus may be implemented in the form in which separate pieces of apparatus in charge of detailed functions are integrated into single apparatus.

In an embodiment, the power supply 200 may apply a current or a voltage to the preliminary battery 1000 in various ways for various purposes. For example, as will be described below, during an impregnation process of impregnating the first electrode and the second electrode by injecting an electrolyte solution into the preliminary battery 1000, a current or a voltage may be applied to the preliminary battery 1000 to electrify the first electrode and the second electrode, and after the impregnation process is completed, a current or a voltage may be applied to the preliminary battery 1000 to charge and discharge the preliminary battery 1000 for the purpose of activating the preliminary battery 1000. The power supply 200 may apply a current or a voltage within a range according to each purpose to the preliminary battery 1000 to achieve a preset purpose (e.g., electrification of each electrode, activated charge/discharge, etc.) according to an instruction of a controller 400 to be described below.

In an embodiment, the power module 210 may be electrically connected to the first electrode and the second electrode of the preliminary battery 1000 to apply a current or a voltage to the first electrode or the second electrode. To this end, the power module 210 may include power supply apparatus 211 for supplying power and a power circuit 212 constituting a circuit between the power module 210 and the preliminary battery 1000, and the power circuit 212 may include a first line 2121 electrically connected to the first electrode of the preliminary battery 1000 and a second line 2122 electrically connected to the second electrode of the preliminary battery 1000.

In an embodiment, the first electrode potential measuring module 220 may be electrically connected to the first electrode to measure the potential of the first electrode.

In an embodiment, the first electrode potential measuring module 220 may be configured separately from the power module 210 described above. That is, the first electrode potential measuring module 220 may be electrically connected to the first electrode separately from the power circuit 212 to measure the potential of the first electrode.

In an embodiment, the first electrode potential measuring module 220 may measure a potential relative to a lithium redox potential of the first electrode.

In an embodiment, the first electrode potential measuring module 220 may be electrically connected to the first electrode to measure a potential relative to a lithium redox potential (vs Li/Li⁺) of the first electrode.

In an embodiment, the first electrode potential measuring module 220 may include a first reference electrode connected to the first electrode to provide a predetermined reference potential.

In an embodiment, the reference potential may mean the lithium redox potential (Li/Li⁺).

In an embodiment, the first electrode potential measuring module 220 may be configured according to a technique known in the art without limitation, to provide the reference potential as described above to measure the potential of the first electrode relative to the reference potential. To this end, the first electrode potential measuring module 220 may include the first reference electrode corresponding to a reference electrode, and may additionally include additional electrodes such as a working electrode and an auxiliary electrode, a voltmeter, and the like as necessary. The first electrode potential measuring module 220 may further include a component such as a communication unit capable of electrically transmitting a potential value measured by the controller 400 and/or a power control module 240 to be described below.

In an embodiment, the first reference electrode may include, but is not limited to, materials such as a lithium titanate oxide (LTO), lithium-ferric phosphate (LFP), lithium metal, platinum, and silver.

In an embodiment, the second electrode potential measuring module 230 may be electrically connected to the second electrode to measure the potential of the second electrode.

In an embodiment, the second electrode potential measuring module 230 may be configured separately from the power module 210 described above. That is, the second electrode potential measuring module 230 may be electrically connected to the second electrode separately from the power circuit 212 to measure the potential of the second electrode.

In an embodiment, the second electrode potential measuring module 230 may measure a potential relative to a lithium redox potential of the second electrode.

In an embodiment, the second electrode potential measuring module 230 may be electrically connected to the second electrode to measure a potential relative to a lithium redox potential (vs Li/Li⁺) of the second electrode.

In an embodiment, the second electrode potential measuring module 230 may include a second reference electrode connected to the second electrode to provide a predetermined reference potential.

In an embodiment, the reference potential may mean the lithium redox potential (Li/Li⁺).

In an embodiment, the second electrode potential measuring module 230 may be configured according to a technique known in the art without limitation, to provide the reference potential as described above to measure the potential of the second electrode relative to the reference potential. To this end, the second electrode potential measuring module 230 may include the second reference electrode corresponding to the reference electrode, and may additionally include additional electrodes such as a working electrode and an auxiliary electrode, a voltmeter, and the like as necessary. The second electrode potential measuring module 230 may further include a component such as a communication unit capable of electrically transmitting a potential value measured by the controller 400 and/or the power control module 240 to be described below.

In an embodiment, the second reference electrode may include, but is not limited to, materials such as a lithium titanate oxide (LTO), lithium-ferric phosphate (LFP), lithium metal, platinum, and silver.

In an embodiment, the first electrode potential measuring module 220 and the second electrode potential measuring module 230 may be configured the same as each other. Alternatively, the first electrode potential measuring module 220 and the second electrode potential measuring module 230 may be configured differently from each other without departing from the scope of the definitions provided in the present disclosure.

In an embodiment, the manufacturing apparatus may further include the controller 400 controlling the power supply 200 and the injection portion 300. The power supply 200 may further include the power control module 240 controlling the power module 210 according to an instruction of the controller 400. The power control module 240 may include an impregnation process control unit 241 controlling a current or a voltage applied from the power module 210 to the preliminary battery 1000 based on the potential of the first electrode measured by the first electrode potential measuring module 220 and the potential of the second electrode measured by the second electrode potential measuring module 230.

In an embodiment, the controller 400 may control the power supply 200 and the injection portion 300. The controller 400 may self-compute an electrical signal received from the power supply 200 and/or the injection portion 300 and transmit an instruction in the form of an electrical signal to the power supply 200 and the injection portion 300 on its own. The controller 400 may transmit an instruction in the form of an electrical signal to the power supply 200 and the injection portion 300 according to a user's operation. To this end, the controller 400 may be implemented as a processor or a set of other circuits to receive an electrical signal from another object and/or transmit an electrical signal to another object, and/or may process an electrical signal on its own without limitation, and/or process a signal without limitation by a user's operation.

In an embodiment, the power control module 240 may further include an activation process control unit 242 controlling a charge/discharge current or voltage applied from the power module 210 to the preliminary battery 1000.

In an embodiment, the power control module 240, the impregnation process control unit 241, and the activation process control unit 242 may be implemented as a processor or a set of other circuits to receive an electrical signal from another object and/or transmit an electrical signal to another object, and/or process an electrical signal on its own without limitation.

In an embodiment, the power control module 240 may control the current or the voltage output from the power module 210 by controlling the power module 210 according to an instruction of the controller 400. In this way, the current or the voltage applied from the power module 210 to the preliminary battery 1000 may be controlled.

In an embodiment, the power control module 240 may control the power module 210 by transmitting an electrical signal to the power module 210.

As described above, the power supply 200 may apply a current or a voltage to the preliminary battery 1000 in various ways for various purposes. To this end, the power control module 240 may include the impregnation process control unit 241 for controlling a current or a voltage applied to the preliminary battery 1000 in an impregnation process to be described below, and the activation process control unit 242 for controlling a current or a voltage applied to the preliminary battery 1000 in an activation process to be described below.

In an embodiment, the impregnation process control unit 241 may control the current or the voltage applied from the power module 210 to the preliminary battery 1000 based on the potential of the first electrode measured by the first electrode potential measuring module 220 and the potential of the second electrode measured by the second electrode potential measuring module 230.

According to an embodiment, the impregnation process control unit 241 may control the current or the voltage applied to the preliminary battery 1000 so that the potential of the first electrode (vs Li/Li⁺) and the potential of the second electrode (vs Li/Li⁺) reach a predetermined potential. To this end, the impregnation process control unit 241 may receive the potential of each of the first and second electrodes from the first electrode potential measuring module 220 and the second electrode potential measuring module 230 in real time, and control the power module 210 based on the received potential value information.

In an embodiment, the activation process control unit 242 may control a charge/discharge current or voltage applied from the power module 210 to the preliminary battery 1000.

According to an embodiment, the activation process control unit 242 may control a current or a voltage applied to the preliminary battery 1000 to charge and discharge the preliminary battery 1000 according to the activation process to be described below.

In an embodiment, the power control module 240 may select to drive either the impregnation process control unit 241 or the activation process control unit 242 under the control of the controller 400.

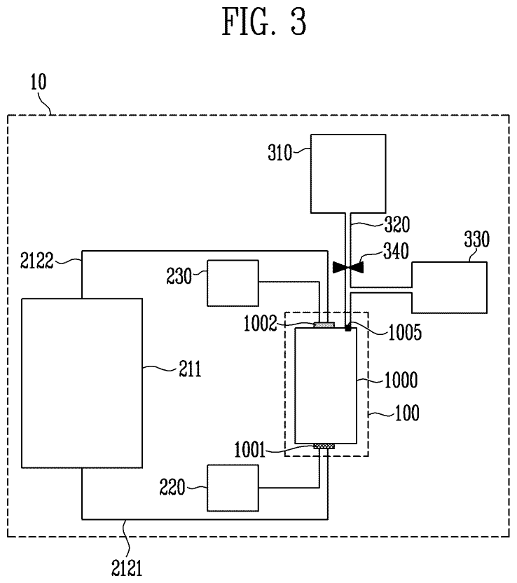

FIG. 3 is a diagram illustrating an example in which the preliminary battery 1000 is arranged in the manufacturing apparatus 10 according to an embodiment.

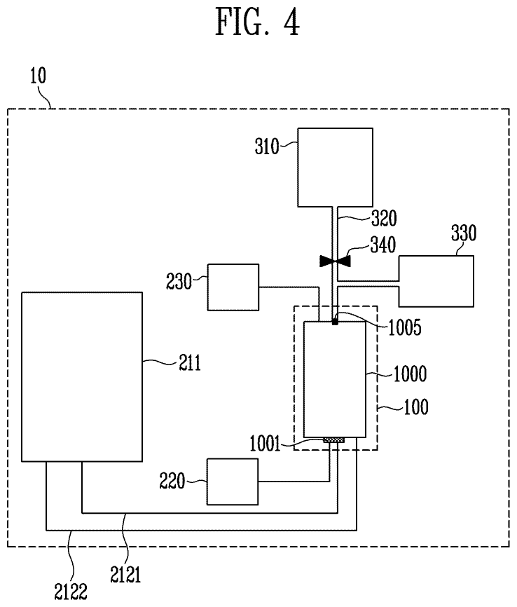

FIG. 4 is a diagram illustrating another example in which the preliminary battery 1000 is arranged in the manufacturing apparatus 10 according to an embodiment.

Referring to FIGS. 3 and 4, in an embodiment, the injection portion 300 may include an injection tank 310 storing an electrolyte solution, an injection line 320 having one end connected to the injection tank 310 and the other end connected to the preliminary battery 1000 to provide an injection path for the electrolyte solution, an injection pump (not shown) causing the electrolyte solution to flow from the injection tank 310 to the preliminary battery 1000, and a vacuum pump 330 controlling the pressure inside the preliminary battery 1000.

In an embodiment, the injection portion 300 may be implemented as single injection apparatus. The injection apparatus may be implemented in the form in which separate pieces of apparatus in charge of detailed functions are integrated into single apparatus.

In an embodiment, the vacuum pump 330 may be connected to the preliminary battery 1000 to control the preliminary battery 1000 so that the inside of the preliminary battery 1000 is in a vacuum state by decompressing the preliminary battery 1000.

In an embodiment, the vacuum pump 330 may be connected to the injection line 320 at a portion of the injection line 320.

In the above embodiment, the injection line 320 may further include a valve 340 thereon which adjusts opening and closing of the injection line 320 between the portion to which the vacuum pump 330 is connected and the injection tank 310.

Referring back to FIG. 3, in an embodiment, the preliminary battery 1000 may be a prismatic battery. The preliminary battery 1000 may include a first electrode terminal 1001 and a second electrode terminal 1002 protruding from the case to the outside, and may include an injection port 1005 formed on the case. The first electrode terminal 1001 may be electrically connected to the first electrode of the preliminary battery 1000, and the second electrode terminal 1002 may be electrically connected to the second electrode of the preliminary battery 1000.

Referring to FIG. 3, the preliminary battery 1000 may be mounted on and supported by the support portion 100. The preliminary battery 1000 mounted on the support portion 100 may be connected to the power supply 200 and the injection portion 300.

In an embodiment, the preliminary battery 1000 may be electrically connected to the power supply 200. In a specific embodiment, the power circuit 212 may be connected to the first electrode terminal 1001 and the second electrode terminal 1002 of the preliminary battery 1000 to electrically connect the preliminary battery 1000 and the power module 210. An electrode of the first electrode potential measuring module 220 is connected to the first electrode terminal 1001 of the preliminary battery 1000, and an electrode of the second electrode potential measuring module 230 is connected to the second electrode terminal 1002, so that the preliminary battery 1000 and the first electrode potential measuring module 220, and the preliminary battery 1000 and the second electrode potential measuring module 230 may be electrically connected.

In an embodiment, the preliminary battery 1000 may be connected to the injection portion 300. In a specific embodiment, the other end of the injection line 320 is connected to the injection port 1005 of the preliminary battery 1000, so that the preliminary battery 1000 and the injection portion 300 may be connected.

However, although FIG. 3 shows that the first electrode terminal 1001 and the second electrode terminal 1002 extend from different surfaces in different directions, unlike the embodiment shown in FIG. 3, the first electrode terminal 1001 and the second electrode terminal 1002 may extend from the same surface in the same direction.

In FIG. 3, the injection port 1005 is shown to be formed on the same surface as the second electrode terminal 1002, but a position where the injection port 1005 is formed might not be particularly limited.

Referring back to FIG. 4, in an embodiment, the preliminary battery 1000 may be a cylindrical battery. The above-described preliminary battery 1000 may include the first electrode terminal 1001 protruding from the case to the outside, but the case may serve as the second electrode terminal 1002 without separately providing the second electrode terminal 1002. The preliminary battery 1000 may include the injection port 1005 formed on the case. The first electrode terminal 1001 may be electrically connected to the first electrode of the preliminary battery 1000, and the case may be electrically connected to the second electrode of the preliminary battery 1000.

Referring to FIG. 4, the preliminary battery 1000 may be mounted on and supported by the support portion 100. The preliminary battery 1000 mounted on the support portion 100 may be connected to the power supply 200 and the injection portion 300.

In an embodiment, the preliminary battery 1000 may be electrically connected to the power supply 200. In a specific embodiment, the power circuit 212 may be connected to the first electrode terminal 1001 and the case of the preliminary battery 1000 to electrically connect the preliminary battery 1000 and the power module 210. The electrode of the first electrode potential measuring module 220 is connected to the first electrode terminal 1001 of the preliminary battery 1000, and the electrode of the second electrode potential measuring module 230 is connected to the case, so that the preliminary battery 1000 and the first electrode potential measuring module 220, and the preliminary battery 1000 and the second electrode potential measuring module 230 may be electrically connected.

In an embodiment, the preliminary battery 1000 may be connected to the injection portion 300. In a specific embodiment, the other end of the injection line 320 is connected to the injection port 1005 of the preliminary battery 1000, so that the preliminary battery 1000 and the injection portion 300 may be connected.

However, unlike the embodiment shown in FIG. 4, the preliminary battery 1000 may be configured to include a second electrode terminal.

Although FIG. 4 illustrates that the injection port 1005 is formed on a surface facing the surface on which the first electrode terminal 1001 is formed, a position where the injection port 1005 is formed might not be particularly limited.

The manufacturing apparatus 10 according to the present disclosure is apparatus including the support portion 100, the power supply 200, the injection portion 300, and the controller 400 as described above, and may perform an impregnation process and an activation process to be described below using single apparatus.

Although the manufacturing apparatus 10 of FIGS. 1 to 4 is shown as having one preliminary battery 1000 to be manufactured, such an illustration is optional, and it goes without saying that the manufacturing apparatus 10 may be configured so that a plurality of preliminary batteries 1000 are manufactured at the same time as necessary without departing from the scope of the definitions provided in the present disclosure.

A manufacturing method for secondary battery according to an embodiment of the present disclosure includes: a preparation step of arranging the preliminary battery 1000 including a first electrode and a second electrode; an injection step of injecting an electrolyte solution into the preliminary battery 1000 after the preparation step; and a voltage application step of applying a voltage to the first electrode and the second electrode of the preliminary battery 1000 after the preparation step. In the voltage application step, a voltage may be applied to the first electrode and the second electrode so that the first electrode reaches a first potential and the second electrode reaches a second potential.

In an embodiment, the preliminary battery 1000 may include the first electrode and the second electrode. In a specific embodiment, each of the first electrode and the second electrode may be included in the preliminary battery 1000 in the form of an electrode assembly in a non-limiting form in which a plurality of first electrodes and a plurality of second electrodes are stacked, and in a more specific embodiment, the electrode assembly may further include a separator in addition to the first electrode and the second electrode, so that the first electrode, the second electrode, and the separator are included in the preliminary battery 1000 in the form of the electrode assembly in the non-limiting form in which the first electrode, the second electrode, and the separator are stacked.

In an embodiment, the first electrode and the second electrode may be either a cathode or an anode, respectively. In a specific embodiment, the first electrode may be a cathode, and the second electrode may be an anode, but are not necessarily limited thereto.

According to an embodiment, the first electrode and the second electrode may each include an electrode current collector and an electrode active material applied to at least one surface of the electrode current collector.

According to an embodiment, the cathode may include a cathode current collector and a cathode active material. The cathode current collector may include a known conductive material to the extent which the cathode current collector does not cause a chemical reaction in a lithium secondary battery. The cathode current collector may include, for example, one of stainless steel, nickel (Ni), aluminum (Al), titanium (Ti), copper (Cu), or an alloy thereof, and may be provided in various forms such as a film, a sheet, and foil. The cathode active material may include a material which lithium ions may be inserted into and extracted from. The cathode active material may be, for example, a lithium metal oxide.

As described above, in one embodiment, the first electrode may be the cathode. In this case, the first electrode may include a lithium metal oxide as a first electrode active material.

According to embodiments, the first electrode active material may include a lithium-transition metal composite oxide. In a specific example, the first electrode active material may include a lithium-nickel metal composite oxide. The lithium-nickel metal composite oxide may further include at least one of cobalt (Co), manganese (Mn), or aluminum (Al).

In some embodiments, the first electrode active material or the lithium-nickel metal composite oxide may include a layered structure or a crystal structure represented by the following Formula 1.

LiₓNiₐM_{b}O_{2+z} Formula 1

In Formula 1, 0.9≤x≤1.2, 0.6≤a≤0.99, 0.01≤b≤0.4, and −0.5≤z≤0.1 may be satisfied. As mentioned above, M may include Co, Mn and/or Al.

The chemical structure represented by Formula 1 represents the bonding relationship included in the layered structure or the crystal structure of the first electrode active material and does not exclude other additional elements. For example, M may include Co and/or Mn, and Co and/or Mn may be provided as main active elements of the first electrode active material together with Ni. Formula 1 is provided to express the bonding relationship of the main active elements and should be understood in a way that encompasses the introduction and substitution of additional elements.

In an embodiment, the first electrode active material or the lithium-nickel metal composite oxide may include a layered structure or a crystal structure represented by the following Formula 1-1.

LiₓNiₐM1_{b1}M2_{b2}O_{2+z} Formula 1-1

In Formula 1-1, M1 may include Co, Mn, and/or Al. M2 may include the auxiliary elements described above. In Formula 1-1, 0.9≤x≤1.2, 0.6≤a≤0.99, 0.01≤b1+b2≤0.4, and −0.5≤z≤0.1 may be satisfied.

In an embodiment, the first electrode active material may include a lithium metal oxide. Specifically, the first electrode active material may include the above-described lithium-nickel metal composite oxide or a lithium iron phosphate (LFP)-based oxide represented by the chemical formula of LiFePO₄.

In an embodiment, the lithium metal oxide may include a lithium iron phosphate (LFP)-based oxide or a nickel-cobalt-manganese (NCM)-based oxide. In a specific embodiment, the lithium metal oxide may be a lithium iron phosphate (LFP)-based oxide or a nickel-cobalt-manganese (NCM)-based oxide.

According to an embodiment, the anode may include an anode current collector and an anode active material. The anode may include an anode current collector and an anode active material applied to at least one surface of the anode current collector. The anode current collector may include a known conductive material to the extent which the anode current collector does not cause a chemical reaction in a lithium secondary battery. The anode current collector may include, for example, one of stainless steel, nickel (Ni), aluminum (Al), titanium (Ti), copper (Cu), or an alloy thereof, and may be provided in various forms such as a film, a sheet, and foil. The anode active material may include a material which lithium ions may be inserted into and extracted from. The anode active material may include, for example, one of a carbon-based material, such as crystalline carbon, amorphous carbon, a carbon composite, and carbon fiber, a lithium alloy, silicon (Si), or tin (Sn) or a combination thereof.

For example, as the anode active material, a carbon-based active material including a carbon-based material such as crystalline carbon, amorphous carbon, a carbon composite, or carbon fiber; a metal-based active material including lithium metal or a lithium alloy; a silicon-based active material including a silicon (Si)-containing material; or a tin (Sn)-containing material may be used.

Examples of the amorphous carbon include hard carbon, soft carbon, coke, a mesocarbon microbead (MCMB), and mesophase pitch-based carbon fiber (MPCF).

Examples of the crystalline carbon include graphite-based carbon such as natural graphite, artificial graphite, graphitized coke, graphitized MCMB, and graphitized MPCF.

Examples of the lithium metal include pure lithium metal or lithium metal in which a protective layer for suppressing dendrite growth or the like is formed. In an embodiment, a lithium metal-containing layer deposited or coated on the anode current collector may be used as the anode active material. In an embodiment, a lithium thin film layer may be used as the anode active material.

The silicon-based active material may provide more increased capacity characteristics. The silicon-based active material may be Si, SiOₓ (0<x≤2), a Si-Q alloy (where Q is an element selected from the group consisting of alkali metals, alkaline earth metals, group 13 elements, group 14 elements, group 15 elements, group 16 elements, transition metals, rare earth elements, and combinations thereof, and not Si), a Si-carbon composite, or a mixture of at least one of these and SiO₂.

As described above, in an embodiment, the second electrode may be an anode. In this case, the second electrode may include a carbon-based active material or a silicon-based active material as a second electrode active material.

In an embodiment, the electrolyte solution may refer to a non-aqueous electrolyte solution used as an electrolyte solution in a secondary battery.

The non-aqueous electrolyte solution includes a lithium salt as an electrolyte and an organic solvent, and the lithium salt is expressed as Li⁺X⁻, for example, and examples of an anion (X⁻) of the lithium salt include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

The organic solvent may include an organic compound which sufficiently dissolves the lithium salt and an additive and having no reactivity in the battery. The organic solvent may include, for example, at least one of a carbonate-based solvent, an ester-based solvent, an ether-based solvent, a ketone-based solvent, an alcohol-based solvent, and an aprotic solvent. Examples of the organic solvent include a propylene carbonate (PC), an ethylene carbonate (EC), a butylene carbonate, a diethyl carbonate (DEC), a dimethyl carbonate (DMC), an ethylmethyl carbonate (EMC), a methylpropyl carbonate, an ethylpropyl carbonate, a dipropyl carbonate, a vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ester (DEGDME), dimethoxyethane, tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, and propylene sulfite, which may be used alone or in combination of two or more.

The non-aqueous electrolyte solution may further include an additive. The additive may include, for example, a cyclic carbonate-based compound, a fluorine-substituted cyclic carbonate-based compound, a sultone-based compound, a cyclic sulfate-based compound, a cyclic sulfite-based compound, a phosphate-based compound, and a borate-based compound.

The cyclic carbonate-based compound may include a vinylene carbonate (VC), a vinyl ethylene carbonate (VEC), and the like.

The fluorine-substituted cyclic carbonate-based compound may include a fluoroethylene carbonate (FEC), and the like.

The sultone-based compound may include 1,3-propane sultone, 1,3-propene sultone and 1,4-butane sulton, and the like.

The cyclic sulfate-based compound may include 1,2-ethylene sulfate, 1,2-propylene sulfate, and the like.

The cyclic sulfite-based compound may include ethylene sulfite, butylene sulfite, and the like.

The phosphate-based compound may include lithium difluoro bis-oxalato phosphate, lithium difluoro phosphate, and the like.

The borate-based compound may include lithium bis(oxalate) borate, and the like.

In an embodiment, the preparation step may refer to a step of arranging the preliminary battery 1000 including the first electrode and the second electrode. In the preparation step, the preliminary battery 1000 may be fixedly supported to limit movement to prevent or mitigate a process failure due to an unintended movement of the preliminary battery 1000 during the manufacturing process according to the present disclosure, but is not necessarily limited thereto, and may be arranged to allow some movement as necessary. The configurations of the preliminary battery 1000 and the first electrode and the second electrode constituting the preliminary battery are the same as those described above, and therefore, repetitive descriptions already mentioned will be omitted below.

In an embodiment, the injection step may refer to a step of injecting the electrolyte solution into the preliminary battery 1000 after the preparation step. When the electrolyte solution is injected into the preliminary battery 1000 by the injection step, specifically, into the case of the preliminary battery 1000, the first electrode and the second electrode accommodated in the case may be impregnated with the injected electrolyte solution.

Because the electrode assembly is impregnated with the electrolyte solution, the electrolyte solution may penetrate into the electrode assembly, and the degree to which the electrolyte solution penetrates into the electrode assembly as the electrode assembly is impregnated with the electrolyte solution may be referred to as “impregnation property”. As the impregnation property in the impregnation process in the manufacturing process increases, the performance of the secondary battery may be improved.

In an embodiment, the injection step may refer to a step of injecting the electrolyte solution into the preliminary battery 1000 after removing gas present in the preliminary battery 1000 by controlling the pressure inside the preliminary battery 1000 by depressurization, specifically the pressure inside the case of the preliminary battery 1000 to create a vacuum environment after the preparation step.

In an embodiment, the voltage application step may refer to a step of applying a voltage to the first electrode and the second electrode of the preliminary battery 1000 after the preparation step. In an embodiment, the voltage application step may be performed to further increase the above-described impregnation property.

In general, the penetration of the electrolyte solution into the electrode assembly is closely related to the composition of the electrode (especially the active material layer) and the electrolyte solution. In addition, capillary forces between each electrode and the electrolyte solution may act as the main penetrating power.

The voltage application step may be performed for the purpose of further improving the impregnation property by electrifying the first electrode and the second electrode to a certain extent, thereby inducing electrostatic interaction between the electrode and the electrolyte solution, and consequently adding the penetrating power.

In an embodiment, the voltage application step may refer to a step of applying a voltage to the first electrode and the second electrode after removing gas present in the preliminary battery 1000 by controlling the pressure inside the preliminary battery 1000 by depressurization, specifically the pressure inside the case of the preliminary battery 1000 to create a vacuum environment after the preparation step.

In an embodiment, in the voltage application step, a voltage may be applied to the first electrode and the second electrode so that the first electrode reaches a first potential and the second electrode reaches a second potential, which will be described in detail below.

In the voltage application step, a voltage may be applied to the first electrode and the second electrode so that the first electrode reaches the first potential and the second electrode reaches the second potential, and then the voltage may be continuously applied to maintain the above-described potentials for a predetermined time.

In an embodiment, in the manufacturing method, after one of the injection step or the voltage application step is performed, another step may be sequentially performed.

In a specific embodiment, in the manufacturing method, the voltage application step may be sequentially performed after the injection step. In a more specific embodiment, as described above, when the injection step includes the step of injecting the electrolyte solution into the preliminary battery 1000 after removing the gas present in the preliminary battery 1000 by controlling the pressure inside the preliminary battery 1000 by depressurization to create a vacuum environment after the preparation step, the manufacturing method may be performed so that the voltage application step is performed after controlling the pressure inside the preliminary battery 1000 by pressurization to create an atmospheric pressure environment after the step of injecting the electrolyte solution into the preliminary battery 1000.

In a specific embodiment, in the manufacturing method, the injection step may be sequentially performed after the voltage application step. In a more specific embodiment, as described above, when the voltage application step includes the step of applying the voltage to the first electrode and the second electrode after removing the gas present in the preliminary battery 1000 by controlling the pressure inside the preliminary battery 1000 by depressurization to create a vacuum environment after the preparation step, the manufacturing method may be performed so that the injection step is performed after controlling the pressure inside the preliminary battery 1000 by pressurization to create an atmospheric pressure environment after the step of applying the voltage to the first and second electrodes.

In an embodiment, in the manufacturing method, the injection step and the voltage application step may be performed in parallel.

In a specific embodiment, in the manufacturing method, the injection step and the voltage application step may be performed simultaneously, and at least a portion of the injection step and at least a portion of the voltage application step are performed in parallel within the same time range.

In an embodiment, the first potential may be between 3 V and 3.6 V relative to the lithium redox potential. That is, the first potential may be from 3 V (vs Li/Li⁺) to 3.6 V (vs Li/Li⁺).

In an embodiment, the first electrode active material may be a lithium metal oxide, and the lithium metal oxide may be an NCM-based oxide, as described above. When an NCM-based oxide is used as an electrode active material, the initial potential is about 3 V (vs Li/Li⁺), and charging may start at a potential of 3.6 V (vs Li/Li⁺) or higher. Therefore, by controlling the first potential within the above numerical range, impregnation may be performed more smoothly by suppressing or reducing the possibility of initiating an unintended side reaction in the impregnation process.

In an embodiment, the second potential may be between 2 V and 3 V relative to the lithium redox potential. That is, the second potential may be from 2 V (vs Li/Li⁺) to 3 V (vs Li/Li⁺).

In an embodiment, the second electrode active material may be a carbon-based active material or a silicon-based active material as described above. When the above-described active material is used as an electrode active material, the initial potential is about 3 V (vs Li/Li⁺), and the decomposition reaction of the electrolyte solution below 1.8 V (vs Li/Li⁺) may be observed, and accordingly, there is a possibility that a solid electrolyte interphase (SEI) layer is formed during the impregnation process. Therefore, by controlling the second potential within the above numerical range, impregnation may be performed more smoothly by suppressing or reducing the possibility of initiating an unintended side reaction in the impregnation process.

As described above, by limiting the voltage applied to the first electrode and the second electrode in the voltage application step to a specific value relative to the predetermined reference potential, when a plurality of preliminary batteries 1000 are manufactured simultaneously or sequentially, occurrence of deviation in impregnation between each preliminary battery 1000 may be suppressed or reduced, and to manufacture each preliminary battery 1000 to exhibit the uniform impregnation property.

In an embodiment, the difference between the first potential and the second potential may be between 0.5 V and 2.5 V. When the difference is below the above numerical range, the effect of improving the impregnation property by performing the voltage application step may be insignificant, and when the difference exceeds the above numerical range, an unintended side reaction may be initiated in the impregnation process as described above.

In the present disclosure, the injection step and the voltage application step may constitute the impregnation process. Therefore, the impregnation process may refer to a series of processes including the injection step and the voltage application step.

In an embodiment, the manufacturing method may further include an aging step of leaving the preliminary battery 1000 at room temperature after the injection step and the voltage application step. The aging step may be performed to stabilize the preliminary battery 1000 by leaving the preliminary battery 1000, into which the electrolyte solution is injected, at room temperature and aging the preliminary battery 1000.

In an embodiment, the aging step may be performed simultaneously with the progress of the voltage application step after the injection step is completed, or may be sequentially performed after both the injection step and the voltage application step end. When the preliminary battery 1000 is a prismatic battery, the aging step may be performed in the above-described manner, but is not necessarily limited thereto.

In an embodiment, the aging step may be sequentially performed after both the injection step and the voltage application step are completed, and after both a physical impregnation step and a pre-charge step, which will be described below, are completed. When the preliminary battery 1000 is a cylindrical battery, the aging step may be performed in the above-described manner, but is not necessarily limited thereto.

In an embodiment, the aging step may be performed for up to 24 hours. As described above, because the impregnation process of the present disclosure includes both the injection step and the voltage application step, the impregnation property in the impregnation process is further improved, so that the process time of the aging step required for stabilizing the preliminary battery 1000 may be shortened compared to the prior art.

In an embodiment, the manufacturing method may further include the physical impregnation step of further improving the impregnation property by repeatedly performing a process of pressurizing and depressurizing the inside of the preliminary battery 1000 after the injection step. When the preliminary battery 1000 is a cylindrical battery, the manufacturing method may be performed in the above-described manner, but is not necessarily limited thereto.

In an embodiment, the manufacturing method may further include the pre-charge step for activating the preliminary battery 1000 after the injection step and the voltage application step. The pre-charge step is a step of performing a preliminary charge on the preliminary battery 1000 in which the electrolyte solution injection and electrode impregnation have been completed, and may be included as a part of the activation process. A post-process, such as an activation process after the pre-charge step, may be appropriately performed by employing a known technique as necessary.

Hereinafter, an embodiment of a manufacturing method for secondary battery using manufacturing apparatus for secondary battery according to an embodiment of the present disclosure will be further described. However, the matters described in the embodiments are merely illustrative of the present disclosure and do not limit the scope of the appended claims, and it is obvious to those skilled in the art that various changes and modifications to the embodiments are possible within the scope and technical spirit of the present disclosure, and it is natural that such changes and modifications belong to the appended claims.

In an embodiment, the preliminary battery 1000 including the first electrode and the second electrode may be mounted on and supported by the support portion 100 of the manufacturing apparatus 10 to be arranged on the manufacturing apparatus 10. This allows the above preparation step to be performed.

In an embodiment, the preliminary battery 1000 arranged as described above is connected to the injection portion 300, and may be electrically connected to the power supply 200. Specifically, the injection line 320 of the injection portion 300 may be connected to the injection port 1005 formed on the case of the preliminary battery 1000. In addition, the power module 210 may be electrically connected to the first electrode and the second electrode of the preliminary battery 1000, the first electrode potential measuring module 220 may be electrically connected to the first electrode of the preliminary battery 1000, and the second electrode potential measuring module 230 may be electrically connected to the second electrode of the preliminary battery 1000. Under such a constitutive coupling relationship, the above-described injection step and voltage application step may be performed.

In an embodiment, the connection between the preliminary battery 1000 and the injection portion 300 may be released by disconnecting the injection line 320 from the injection port 1005 upon completion of the injection step. When the voltage application step is completed, the electrical connection between the first electrode potential measuring module 220 and the first electrode may be released, and the electrical connection between the second electrode potential measuring module 230 and the second electrode may be released. Meanwhile, the electrical connection between the power module 210 and the first electrode and the second electrode of the preliminary battery 1000 may be maintained. Under such a constitutive coupling relationship, the above-described pre-charge step may be performed, and furthermore, other steps of the activation process including the above-described pre-charge step may be performed sequentially or in parallel.

A secondary battery according to an embodiment of the present disclosure may be manufactured according to a manufacturing method including a manufacturing method for secondary battery according to an embodiment of the present disclosure. The secondary battery according to an embodiment of the present disclosure may include a battery cell manufactured according to the manufacturing method including the manufacturing method for secondary battery according to an embodiment of the present disclosure.

A battery cell according to an embodiment of the present disclosure may be used not only as a battery cell used as a power source of a small device, but also preferably as a unit cell of a battery module and/or a battery pack of a medium or large device including a plurality of battery cells. Examples of the small device include a mobile phone, a notebook computer, a camera, and the like, and examples of the medium or large device include an electric vehicle, a hybrid electric vehicle, a plug-in hybrid electric vehicle, and a power storage system, but are not limited thereto.

The descriptions as set forth above are merely examples of applying the principles of the present disclosure, and other configurations may be further included without departing from the scope of the present disclosure.

What is claimed is:

1. Manufacturing apparatus for secondary battery, comprising:
a support portion on which a preliminary battery including a first electrode and a second electrode is mounted and supported;
a power supply applying a current or a voltage to the preliminary battery; and
an injection portion injecting an electrolyte solution into the preliminary battery,
wherein the power supply comprises:
a power module electrically connected to the first electrode and the second electrode of the preliminary battery to apply the current or the voltage to the first electrode and the second electrode;
a first electrode potential measuring module electrically connected to the first electrode of the preliminary battery to measure a potential of the first electrode; and
a second electrode potential measuring module electrically connected to the second electrode of the preliminary battery to measure a potential of the second electrode.

2. The manufacturing apparatus for secondary battery of claim 1, wherein the first electrode potential measuring module measures a potential relative to a lithium redox potential of the first electrode.

3. The manufacturing apparatus for secondary battery of claim 1, wherein the first electrode potential measuring module includes a first reference electrode connected to the first electrode to provide a predetermined reference potential.

4. The manufacturing apparatus for secondary battery of claim 1, wherein the second electrode potential measuring module measures a potential relative to a lithium redox potential of the second electrode.

5. The manufacturing apparatus for secondary battery of claim 1, wherein the second electrode potential measuring module includes a second reference electrode connected to the second electrode to provide a predetermined reference potential.

6. The manufacturing apparatus for secondary battery of claim 1, further comprising a controller controlling the power supply and the injection portion,
wherein the power supply further comprises a power control module controlling the power module according to an instruction of the controller, and
wherein the power control module comprises an impregnation process control unit controlling the current or the voltage applied from the power module to the preliminary battery based on the potential of the first electrode measured by the first electrode potential measuring module and the potential of the second electrode measured by the second electrode potential measuring module.

7. The manufacturing apparatus for secondary battery of claim 6, wherein the power control module further comprises an activation process control unit controlling a charge/discharge current or voltage applied from the power module to the preliminary battery.

8. The manufacturing apparatus for secondary battery of claim 1, wherein the injection portion comprises:
an injection tank storing the electrolyte solution;
an injection line having one end connected to the injection tank and another end connected to the preliminary battery to provide an injection path for the electrolyte solution;
an injection pump causing the electrolyte solution to flow from the injection tank to the preliminary battery; and
a vacuum pump controlling pressure inside the preliminary battery.

9. A manufacturing method for secondary battery, comprising:
a preparation step of arranging a preliminary battery including a first electrode and a second electrode;
an injection step of injecting an electrolyte solution into the preliminary battery after the preparation step; and
a voltage application step of applying a voltage to the first electrode and the second electrode of the preliminary battery after the preparation step,
wherein in the voltage application step, the voltage is applied to the first electrode and the second electrode so that the first electrode reaches a first potential and the second electrode reaches a second potential.

10. The method of claim 9, wherein, after one of the injection step and the voltage application step is performed, another step is sequentially performed.

11. The method of claim 9, wherein the injection step and the voltage application step are performed in parallel.

12. The method of claim 9, wherein the first potential is between 3 V and 3.6 V relative to a lithium redox potential.

13. The method of claim 9, wherein the second potential is between 2 V and 3 V relative to a lithium redox potential.

14. The method of claim 9, further comprising an aging step of leaving the preliminary battery at room temperature after the injection step and the voltage application step.

15. The method of claim 9, further comprising a pre-charge step for activating the preliminary battery after the injection step and the voltage application step.
